(19) United States
(12) Patent Application Publication
(10) Pub. No.: US 2018/0327656 A1
(43) Pub. Date: Nov. 15, 2018

(54) PRESSURE ACTIVATED CURABLE RESIN COATED PROPPANTS

(71) Applicant: Fairmount Santrol, Inc., Chesterland, OH (US)

(72) Inventors: Ramanan Pitchumani, Missouri City, TX (US); Kanth Josyula, Sugar Land, TX (US); Abraham Rodriguez, Sugar Land, TX (US)

(73) Assignee: Fairmount Santrol, Inc., Chesterland, OH (US)

(21) Appl. No.: 15/774,644

(22) PCT Filed: Nov. 7, 2016
(86) PCT No.: PCT/US2016/060779

§ 371 Date: May 9, 2018

Related U.S. Application Data
(60) Provisional application No. 62/252,885, filed on Nov. 9, 2015.

(51) Int. Cl. C09K 8/80; C09K 8/68; E21B 43/267

(52) U.S. Cl. CPC C09K 8/805; E21B 43/267; C09K 8/685

(57) ABSTRACT

A curable resin coated proppant which resists damage due to premature curing in the summertime comprises a proppant particle substrate and a curable resin coating on the proppant particle substrate. The curable resin coating comprises a curable polymer resin, a conventional (aldehyde functional) curing agent for the curable polymer resin, an organofunctional compound comprising one or more polyols, one or more polyamines or a mixture thereof, and a non-aldehyde functional covalent crosslinking agent for the polymer resin.

### CROSS-REFERENCE TO RELATED APPLICATION

This application claims priority to and all benefit of U.S. Provisional Patent Application Ser. No. 62/252,885, filed on Nov. 9, 2015, titled PRESSURE ACTIVATED CURABLE RESIN COATED PROPPANTS, the entire disclosure of which is fully incorporated herein by reference.

### BACKGROUND

Proppants, which are used to prop open the fractures and fissures in a geological formation formed and/or enlarged by hydraulic fracturing (“fracing”), can be made from a wide variety of different particulate materials. Most commonly they are made from sand and other naturally occurring crush-resistant particulates. In addition, they are also made from synthetic ceramics especially formulated to exhibit high crush strength.

While the majority of proppants are uncoated, a significant portion carry coatings made from synthetic resins, usually a novolac resin or other phenol-formaldehyde resin. Two basic varieties of resin coated proppants are used, those in which the resin coating is fully cured and those in which the resin coating is only partially cured (typically referred to in industry as a “curable” resin coating).

Fully cured resin coatings are used to increase the crush strength of the underlying proppant particulate. Curable resin coatings are used to increase the bond strength and hence coherency of a “poppant pack” which forms when a mass of the proppants consolidate (i.e., the proppants bond together) in fractures and fissures of larger dimension. Drag created by fluids flowing through a proppant pack is often large enough to dislodge individual proppant particulates from the pack. Accordingly, curable resin coatings are provided to bond these individual proppant particulates to one another, thereby preventing them from being dislodged. Bonding occurs because the resin coatings on the individual proppant particulates are in contact with one another as they cure in response to the elevated temperatures and pressures encountered downhole.

In order to cause a curable resin coating to cure, a curing agent for the resin is normally included in the coating. Most often, these curable resin coatings are made from novolac resins. Therefore, hexamethylenetetramine or “hexa” is normally used as the curing agent, since it is inexpensive and readily decomposes at temperatures as low as 195° F. (˜90° C.) to yield formaldehyde for crosslinking the novolac. Additionally or alternatively, curing agents which decompose at lower temperatures to yield formaldehyde for crosslinking can be used. Resorcinol is an example of such an alternative crosslinking agent.

Although the ambient temperature encountered downhole in many geological formations can be 300° F. (˜149° C.) or more, in a not-insignificant number of cases the ambient temperature can be 150° F. (˜66° C.) or less. Curable resin coatings using hexa as the curing agent are essentially ineffective at these temperatures, even if large amounts are used, because these temperatures are just too low to cause the hexa to decompose rapidly. Even if resorcinol or other low temperature activated curing agent is used instead of hexa, the rate of activation of the curing agent is still so slow that these curable resin coatings are also essentially ineffective.

To overcome this problem, it is common practice to include in the hydraulic fracing fluid a plasticizer for the curable resin coating when fracing geological formations having ambient temperatures of about 150° F. (˜66° C.) or less. These plasticizers, which are known in industry as “activators,” soften the curable resin coatings of the individual proppant particulates enough so that they bond to one another in response to the elevated pressures encountered downhole, even at low temperatures.

While these approaches work well, a common problem associated with curable resin coated proppants is premature curing of the resin coating during storage and transport. During summer months, especially in the southern U.S., temperatures inside the silos and rail cars in which these proppants are stored and shipped can reach 125° F. (˜52° C.) and more at relative humidities of 95% or more. Under these conditions, the curing agents in these coatings decompose fast enough to initiate curing of the curable resins in these coatings. Unfortunately, this renders these proppants unfit for subsequent use and also makes them extremely difficult to remove from their silos and railcars.

Still another problem associated with curable resin coated proppants is that they can amalgamate into clumps or masses before they reach their ultimate use locations downhole. This problem, which can become especially troublesome when downhole temperatures are relatively high, e.g., 300° F. (˜149° C.) or more, is known as premature consolidation or well bore consolidation. Once a proppant undergoes premature consolidation, not only is it prevented from moving deeper into smaller cracks and fissures but, in addition, it also blocks additional proppant particles from moving into these smaller cracks and fissures.

### SUMMARY

In accordance with this invention, the above-mentioned premature curing and premature consolidation problems can be eliminated essentially completely or at least substantially reduced without adversely affecting the functionality of the proppant in terms of forming coherent, crush resistant proppant packs by including in the curable resin coatings of these proppants (1) an organofunctional compound comprising a polyol, a polyamine or a mixture of both and (2) a non-aldehyde functional covalent crosslinking agent for the curable polymer resin.

Thus, this invention provides a curable resin coated proppant comprising a proppant particle substrate and a curable resin coating on the proppant particle substrate, wherein the curable resin coating comprises the reaction product obtained when a molten mixture comprising a curable polymer resin, a conventional (aldehyde functional) curing agent for the curable polymer resin, an organofunctional compound comprising one or more polyols, one or more polyamines or a mixture thereof, and a non-aldehyde functional covalent crosslinking agent for the curable polymer resin is coated onto the proppant particle substrate and then solidified in a manner so that the curable polymer resin remains curable.

In addition, this invention also provides an aqueous fracturing fluid comprising an aqueous carrier liquid containing this pressure-activated curable resin coated proppant.

In addition, this invention further provides a method for fracturing a geological formation comprising pumping this fracturing fluid into this formation.

### DETAILED DESCRIPTION

### Definitions

This invention departs from earlier technology at least in that, in this invention, an organofunctional compound comprising a polyol, a polyamine or a mixture of both, and a non-aldehyde functional covalent crosslinking agent for the curable polymer resin are included in the curable resin coating of a curable resin coated proppant. As further discussed below, whether or not any chemical reaction occurs among the different ingredients of this curable resin coating before the inventive proppant is used, or if so the nature of such chemical reaction and the products formed thereby, are unknown as of this writing. We do know, however, that the outermost resin layer of the inventive curable resin coated proppant still remains curable in the same way that the outermost resin layer of conventional curable resin coated proppants still remain curable. Therefore, we believe that, in the same way as occurs in conventional curable resin coated proppants, the curable resin layer of the inventive curable resin coated proppant at least contains some unreacted conventional (i.e., aldehyde functional) curing agent for the curable polymer resin so that additional curing of this outermost curable resin layer can occur when the proppant reaches its ultimate use location downhole.

So, for convenience, at least in some places, we describe the curable resin coating of the inventive curable resin coated proppant as “comprising” the various ingredients used to make it including both the conventional ingredients normally included in such coatings, i.e., the curable polymer resin, the conventional (i.e., aldehyde functional) curing agent for this resin and conventional additives normally included in curable resin coatings of this type, as well as the additional ingredients provided by this invention, i.e., the polyamine and/or polyol organofunctional compound and the non-aldehyde functional covalent crosslinking agent. By this usage, we do not mean to say that some or all of these additional ingredients remain unreacted in the curable resin coating of the inventive proppant. Nor do we mean to say that all of these additional ingredients have reacted to form reaction products in this curable resin coating. Rather, we mean to say either of these situations is possible as is a combination of these situations.

Also, in various places in this disclosure, we indicate that the inventive proppants can form strong, coherent proppant packs. By “coherent,” we mean that these proppant packs resist proppant flowback, which is a common problem associated with proppant packs whose individual proppant particles are insufficiently bonded to one another.

### Proppant Particle Substrate

As indicated above, the pressure-activated curable resin coated proppants of this invention take the form of a proppant particle substrate carrying a coating of a curable resin coating which resists premature curing above ground and premature consolidation downhole.

For this purpose, any particulate solid which has previously been used or may be used in the future as a proppant in connection with the recovery of oil, natural gas and/or natural gas liquids from geological formations can be used as the proppant particle substrate. These materials can have densities as low as ˜1.2 g/cc and as high as ˜5 g/cc and even higher, although the densities of the vast majority will range between ˜1.8 g/cc and ˜5 g/cc, such as for example ˜2.3 to ˜3.5 g/cc, ˜3.6 to ˜4.6 g/cc, and ˜4.7 g/cc and more.

Specific examples include graded sand, bauxite, ceramic materials, glass materials, polymeric materials, resinous materials, rubber materials, nutshells that have been chipped, ground, pulverized or crushed to a suitable size (e.g., walnut, pecan, coconut, almond, ivory nut, brazil nut, and the like), seed shells or fruit pits that have been chipped, ground, pulverized or crushed to a suitable size (e.g., plum, olive, peach, cherry, apricot, etc.), chipped, ground, pulverized or crushed materials from other plants such as corn cobs, composites formed from a binder and a filler material such as solid glass, glass microspheres, fly ash, silica, alumina, fumed carbon, carbon black, graphite, mica, boron, zirconia, talc, kaolin, titanium dioxide, calcium silicate, and the like, as well as combinations of these different materials. Especially interesting are intermediate density ceramics (densities ˜1.8 to 2.0 g/cc), normal frac sand (density ˜2.65 g/cc), bauxite and high density ceramics (density ˜5 g/cc), just to name a few.

### Optional Fully-Cured Resin Coating

Although the curable resin coating of the inventive curable resin coated proppant of this invention can be directly applied to its proppant particle substrate, it may be desirable to interpose one or more intermediate coating layers between this curable resin coating and its proppant particle substrate.

As indicated above, it is well known in industry that the crush strength of a mass of proppants (i.e., a proppant pack) can be increased significantly by providing each proppant particulate, before the proppant is charged downhole, with its own coating of a fully-cured polymer resin. In this context, “fully cured” is used in its conventional sense, meaning that while curing may not be 100% complete nonetheless the vast majority of the curing has already occurred. “Fully-cured” is intended to distinguish these polymer resins from curable polymer resins (commonly referred to in industry as “B-stage” resins”), which although containing enough curing agent to cause full cure nonetheless remain substantially uncured.

In accordance with this optional feature, the ability of a fully cured resin coating to increase crush strength can be taken advantage of by applying one or more intermediate coating layers of a fully cured polymer resin to the proppant particle substrate before the curable resin coating of this invention is applied. As a result, proppant packs formed from the inventive curable resin coated proppant including this optional intermediate coating layer exhibit greater crush strengths compared with proppant packs formed from otherwise identical inventive proppants not including such intermediate coating layers.

To make this optional intermediate coating layer, any polymer resin which has previously been used, or which may be used in the future, for making fully cured resin coatings on proppant particle substrates for increasing their crush strength can be used. Normally, phenol aldehyde resins will be used for this purpose, especially novolac resins, since they work well and are relatively inexpensive.

In addition to polymer resin, a conventional curing agent for this polymer resin will also normally be used to make this optional intermediate coating layer. For this purpose, any curing agent which has been used in the past, or may be used in the future, to make fully cured resin coatings on proppants for increasing crush strength can be used.

As indicated above, in the vast majority of cases, the curable resin coating will be formed from a phenol aldehyde resin, and in particular a novolac resin. If so, the curing agent that will normally be used for curing this resin will be hexamethylenetetramine (“hexa” or “HMTA”), normally in aqueous solutions from about 10 wt. % to about 60 wt. %. As well appreciated in the art, hexa decomposes at elevated temperature to yield formaldehyde and by-product ammonia. In lieu of or in addition to hexa, other analogous curing agents can be used, examples of which include paraformaldehyde, oxazolidines, oxazolidinones, melamine reins, aldehyde donors, and/or phenol-aldehyde resole polymers.

These conventional curing agents are aldehyde functional in the sense that they form covalent crosslinks, specifically methylene crosslinks, between adjacent phenol moieties via the reaction of formaldehyde or analog to form pendant methylol groups which immediately condense to form ether intermediates which, in turn, immediately condense to form covalent methylene linkages. The following reaction scheme, in which hexa is used as the curing agent, illustrates this mechanism.

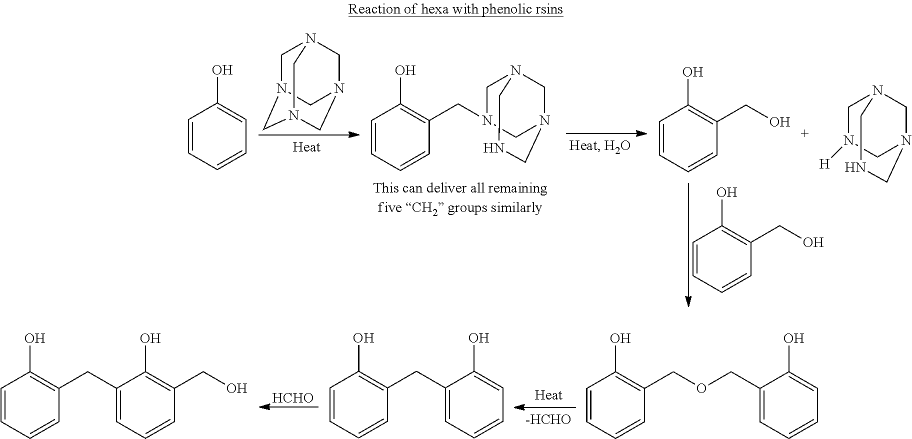

For convenience, therefore, we sometimes refer to these curing agents as “aldehyde functional curing agents.” Other times, we may refer to them as “conventional curing agents,” “conventional aldehyde functional curing agents” or the like.

In addition to conventional, aldehyde functional covalent curing agents, other ingredients which have, or may be, included in the fully cured resin coatings of conventional resin coated proppants can also be included in the intermediate fully cured resin coating layer of this invention. For example, additives referred to in industry as “toughening agents” can be added to reduce the brittle character of the fully cured resin coatings obtained, thereby reducing the tendency of these coatings to generate fines if the crush strength of the proppant is exceeded. Examples include polyethylene glycols such as PEG 400 to PEG 10,000, tung oil and polysiloxane based products such as HP2020 (a proprietary polysiloxane available from Wacker Chemie AG).

The amounts of ingredients that can be used for making these optional fully-cured resin coatings are conventional and well known in industry. For example, to produce each individual intermediate coating layer, the amount of novolac or other resin which is applied to the proppant particle substrate will generally be between about 0.1-10 wt. %, BOS (i.e., based on the weight of sand or other proppant particle substrate being used). More commonly, the amount of polymer resin applied will generally be between about 0.5 wt % to 5 wt. %, BO S. Within these broad ranges, polymer loadings of ≤5 wt. %, ≤4 wt. %, ≤3 wt. %, ≤2 wt. %, and even ≤1.5 wt. %, BOS are interesting. Most typically, the amount of polymer resin used to make each separate intermediate coating layer will be between about 0.10 wt. % and 1.5 wt. % BOS.

Similarly, if hexa is used as the curing agent, conventional amounts can be used, these amounts typically being between about 5 wt. % and 30 wt. %, more typically between about 10 wt. % and 20 wt. %, or even 12 wt. % to 18 wt. %, BOR (i.e., based on the amount of novolac or other curable resin in that particular coating layer).

In addition, if a toughening agent is used, conventional amounts can be added. For example, as much as 40 wt. % BOR and as little as 1 wt. % BOR of these toughening agents can be used. More commonly, the amount of toughening agent used will be about 1.5 to 25 wt. %, or even 2 to 10 wt. %, BOR.

### Curable Resin Coating

To make the curable resin coating of the inventive curable resin coated proppants, any polymer resin which has previously been used, or which may be used in the future, for making the curable resin coating of a curable resin coated proppant can be used. As in the case of the optional intermediate fully cured resin coatings mentioned above, phenol aldehyde resins and especially novolac resins will normally be used for this purpose, since they work well and are relatively inexpensive.

In this connection, it is well understood in industry that the same or essentially the same ingredients in essentially the same amounts as are used to make fully cured resin coatings in proppants are also used to make curable resin coatings in proppants. The difference between these coatings primarily resides in the way they are made.

During manufacture, a fully cured resin coating is kept at an elevated curing temperature long enough to achieve essentially full cure of the resin. So, for example, when a hexa curing agent is used to cure a novolac resin, full cure can be accomplished in as little about 15 seconds if the resin is kept at a temperature of about 385° F. (˜196° C.). However, if the resin is kept at 275° F. (˜135° C.), full cure may take 5 minutes or longer. In contrast, a curable resin coating is typically maintained at lower temperature for a much shorter period of time to prevent any significant amount of curing from occurring. So, for example, if the same novolac resin and hexa curing agent mentioned above are used in the same amounts to make a curable resin coating, the hexa curing agent is not added until the temperature of the resin drops to a fairly low temperature, e.g., 250° F. (˜121° C.) or so. In addition, the resin/hexa curing agent combination is kept at this temperature only for a short period of time, e.g., about 5 to 15 seconds, before it is immediately quenched with water or otherwise cooled to prevent any additional curing from occurring.

The types and amounts of curable polymer resin and conventional aldehyde functional covalent curing agent that are used to make the curable resin coatings of the inventive proppants follow the same principle mentioned above, i.e., the same or essentially the same ingredients in essentially the same amounts as are used to make the above-described fully cured resin coatings can be used to make the curable resin coatings of the inventive curable resin coated proppants. Most typically, therefore, the amount of novolac or other curable resin used to make the curable resin coatings of the inventive proppants will be about 0.1 to 10 wt. %, more commonly about 0.3 to 5 wt % and even more typically % 0.5 to 1.5 wt. %, BOS. Similarly, the amount of hexa or other aldehyde functional curing added will normally be between about 10 to 25 wt. %, more commonly 12 to 20 wt. %, BOR (i.e., based on the weight of the curable polymer resin in this particular coating layer).

### Improved Resistance Against Premature Curing

Premature curing of the curable resin coating of a curable resin coated proppant is believed to be responsible for two different problems associated with this type of proppant, (1) clumping/agglomeration of the proppant when stored and shipped above ground in rail cars and silos during hot summer months and (2) premature consolidation downhole, i.e., consolidation into a proppant pack downhole before the proppant reaches its ultimate use location.

In accordance with this invention, a curable resin coated proppant can be made more resistant to these problems without adversely affecting its functionality in terms of forming coherent, crush resistant proppant packs by incorporating into its curable resin coating (1) an organofunctional compound comprising at least one polyol, at least one polyamine or both and (2) a non-aldehyde functional covalent crosslinking agent for the curable polymer resin which is also capable of chemically reacting with this organofunctional compound.

As indicated above, as of this writing we do not know for sure whether the polyamine and/or polyol organofunctional compound and the non-aldehyde functional covalent crosslinking agent of this invention react with one another or with any of the other ingredients in the curable resin coating of the inventive proppants. What we do know, however, is that the inventive proppants can form strong coherent proppant packs downhole at temperatures as low as 100° F. (˜38° C.) while simultaneously avoiding problems associated with premature curing such as premature consolidation downhole.

Therefore, we surmise that, as a result of this invention, a protective shell surrounding the curable resin coating of each proppant particle is formed when the molten mixture of ingredients forming this curable resin coating solidifies during manufacture. Accordingly, if and when the curable resin coating undergoes premature curing, the curable resin coating covering each proppant particle is prevented from contacting the curable resin coating covering contiguous proppant particles. The result is that contiguous proppant particles are prevented from bonding to one another, which in turn prevents the proppants from clumping/agglomerating during storage above ground in hot summer months as well as premature consolidation downhole.

On the other hand, this protective shell is not so strong that it can resist being degraded, dislodged and/or otherwise destroyed under the elevated pressures found downhole, e.g., 1,000 psi (˜69 bar) or more. As a result, the functioning of these proppants in the sense of being able to form strong, coherent proppant packs downhole capable of resisting proppant particle dislodgement is not adversely affected. This is because the elevated pressures encountered downhole are sufficient to destroy or otherwise degrade this protective shell, thereby releasing the curable resin coatings underlying these protective shells. As a result, contiguous proppant particles can bond to one another in a conventional manner.

The result, therefore, is a new curable resin coated proppant which still functions in the same way as a conventional curable resin coated proppant in the sense of being able to form coherent proppant packs downhole exhibiting limited proppant particle dislodgement. Over and above that, however, the inventive curable resin coated proppant is both insensitive to temperature and humidity in the sense that it resists clumping and agglomeration above ground and premature consolidation downhole. Thus, this proppant can be regarded as being pressure-activated in the sense that it resists consolidation (i.e., it resists forming strong, coherent proppant packs) under the influence of elevated temperature alone. Rather, the elevated pressures found downhole in combination with the elevated temperatures found there are normally necessary to achieve this consolidation.

Still another advantage of the inventive curable resin coated proppant is a reduction in leaching of low molecular weight ingredients. During manufacture, curing of the curable resin of a curable resin coated proppant is terminated before it has proceeded to any significant degree. As a result, the curable resin coatings produced can contain significant amounts of unreacted phenol, oligomers and other low molecular weight ingredients. These ingredients tend to leach out of these curable resin coatings over time, which may be undesirable in some situations. In accordance with this invention, this leaching tendency is essentially prevented by the protective shell which forms surrounding the curable resin coating of each proppant particle.

### Organofunctional Compound

As indicated above, the organofunctional compound that can be used to make the inventive curable resin coated proppants can be a polyol, a polyamine or a mixture of both. Suitable polyamines that can be used for this purpose include any polyamine containing two or more primary amino groups, i.e (—NH₂). Both monomeric polyamines such as ethylene diamine, 1,3-diaminopropane and hexamethylenediamine can be used, as well as polymeric polyamines such as polyethyleneimine. These polyamines may also have molecular weights which are low enough to dissolve in the carrier liquids of the coating compositions and may also be liquids at room temperature, i.e., 20° C. These polyamines also may contain 2-15 carbon atoms, more typically 2-10, or even 2-8, carbon atoms and 2-5, more typically 3-5, primary amino groups. Liquid polyamines having 3-6 carbon atoms are interesting.

The polyols that can be used to make the inventive pressure-activated curable resin coated proppants are any polyol containing two or more pendant hydroxyl groups. Both monomeric polyols such as glycerin, pentaerythritol, ethylene glycol and sucrose can be used, as can polymeric polyols such as polyester polyols and polyether polyols such as polyethylene glycol, polypropylene glycol, and poly(tetramethylene ether) glycol.

These polyols may have molecular weights which are low enough to dissolve in any carrier liquid that may be present and may also be liquids at room temperature, i.e., 20° C. These polyols may contain 2-15 carbon atoms, more typically 2-10, or even 2-8, carbon atoms and 2-5, more typically 3-5, pendant hydroxyl groups. Liquid polyol having 3-6 carbon atoms and 2-4 pendant hydroxyl groups are especially interesting, as are liquid polyols having 3-6 carbon atoms and 3-5 pendant hydroxyl groups. Particular examples of liquid polyols which are useful for this invention include ethylene glycol, propylene glycol, butylene glycol, pentylene glycol, glycerol, trihydroxy butane and trihydroxy pentane.

In a particularly interesting embodiment of this invention, the organofunctional compound used to make the inventive pressure-activated curable resin coated proppants is a polyol which exhibits a plasticizing effect on the curable polymer resin of its curable resin coating. In other words, the organofunctional compound is a plasticizer for the curable polymer resin. Particular examples include polyols based on polyethylene glycol and polypropylene glycol such as the plasticizers mentioned above, i.e., polyethylene glycols exemplified by PEG 400 and PEG 10,000, which are known to plasticize a wide variety of different polymer resins such as phenol aldehyde resins and especially novolac resins. By following this approach, these hydroxyl terminated plasticizers not only participate in forming the protective shell of the inventive proppants but also become chemically bonded to the curable polymer resin forming the curable resin coating of the inventive proppant, thereby forming an integral part of this coating. The result is that no separately supplied activator (plasticizer) need be included in the fracing fluid used to supply these proppants downhole.

### Non-Aldehyde Functional Covalent Crosslinking Agent

As indicated above, in addition to a conventional aldehyde functional covalent crosslinking agent, a non-aldehyde functional covalent crosslinking agent is also include in the reaction mixture used to form the inventive curable resin coated proppants. In this context, a “non-aldehyde functional covalent crosslinking agent” will be understood to refer to a crosslinking agent which causes a covalent crosslink to form between adjacent molecules of a curable polymer resin, which crosslink is not formed between adjacent phenol moieties via the mechanism of methylol formation followed by condensation of the methylol groups into ethers and the subsequent condensation of the ethers into methylene linkages.

Particular non-aldehyde functional covalent crosslinking agents that can be used to make the inventive pressure-activated curable resin coated proppants include organic compounds which contain (or which are capable of reacting to contain) at least two of the following functional groups: epoxides, anhydrides, aldehydes, diisocyanates, carbodiamides, divinyl, or diallyl groups. Particular examples of these covalent crosslinkers include: PEG diglycidyl ether, epichlorohydrin, maleic anhydride, formaldehyde, glyoxal, glutaraldehyde, toluene diisocyanate, methylene diphenyl diisocyanate, 1-ethyl-3-(3-dimethylaminopropyl) carbodiamide, methylene bis acrylamide, and the like.

Especially interesting are the diisocyanates such as toluene-diisocyanate, naphthalenediisocyanate, xylene-diisocyanate, tetramethylene diisocyanate, hexamethylene diisocyanate, trimethylene diisocyanate, trimethyl hexamethylene diisocyanate, cyclohexyl-1,2-diisocyanate, cyclohexylene-1,4-diisocyanate, and diphenylmethanediisocyanates such as 2,4′-diphenylmethanediisocyanate, 4,4′-diphenylmethanediisocyanate and mixtures thereof.

In addition to these diisocyanates, analogous polyisocyanates having three or more pendant isocyantes can also be used. In this regard, it is well understood in the art that the above and similar diisocyanates are commercially available both in monomeric form as well as in what is referred to in industry as “polymeric” form in which each diisocyante molecule is actually made up from approximately 2-10 repeating isocyante monomer units.

For example, MDI is the standard abbreviation for the particular organic chemical identified as diphenylmethane diisocyanate, methylene bisphenyl isocyanate, methylene diphenyl diisocyanate, methylene bis (p-phenyl isocyanate), isocyanic acid: p,p′-methylene diphenyl diester; isocyanic acid: methylene dip-phenylene ester; and 1,1′-methylene bis (isocyanato benzene), all of which refer to the same compound. MDI is available in monomeric form (“MMDI”) as well as “polymeric” form (“p-MDI” or “PMDI”), which typically contains about 30-70% MMDI with the balance being higher-molecular-weight oligomers and isomers typically containing 2-5 methylphenylisocyanate moieties.

For the purposes of this disclosure, it will be understood that we use “diisocyanate” in the same way as in industry to refer to both monomeric diisocyanates and polymeric isocyanates, even though these polymeric isocyanates necessarily contain more than two pendant isocyanate groups. Correspondingly, where we intend to refer to a simple monomeric diisocyanate, “monomeric” or “M” will be used such as in the designations “MMDI” and “monomeric MDI.” In any event, it will be understood that for the purposes of this invention, all such diisocyanates can be used as the non-aldehyde functional covalent crosslinking agent, whether in monomeric form or polymeric form.

In addition to these diisocyanates, additional polyisocyanate-functional compounds that can be used as the non-aldehyde functional covalent crosslinking agents of this invention are the isocyanate-terminated polyurethane prepolymers, such as the prepolymers obtained by reacting toluene diisocyanate with polytetramethylene glycols. Isocyanate terminated hydrophilic polyurethane prepolymers such as those derived from polyether polyurethanes, polyester polyurethanes as well as polycarbonate polyurethanes, can also be used.

In this regard, it is desirable when making the inventive pressure-activated curable resin coated proppants that the non-aldehyde functional covalent crosslinking agents be in liquid form when combined with the other ingredients of the coating compositions. This is because this approach enhances the uniformity with which this crosslinking agent is distributed in the coating composition and hence the uniformity of the crosslinked layer or “shell” that is ultimately produced.

For this purpose, particular crosslinking agents can be selected which are already liquid in form. For example, MMDI, p-MDI and other analogous diisocyanates can be used as is, as they are liquid in form as received from the manufacturer. Additionally or alternatively, the crosslinking agent can be dissolved in a suitable organic solvent. For example, many aliphatic diisocyanates and polyisocyanates are soluble in toluene, acetone and methyl ethyl ketone, while many aromatic diisocyanates and polyisocyanates are soluble in toluene, benzene, xylene, low molecular weight hydrocarbons, etc. Dissolving the isocyanate in an organic solvent may be very helpful, for example, when polymeric and other higher molecular weight diisocyanates are used.

Another especially interesting class of compounds that can be used as the non-aldehyde functional covalent crosslinking agent of this invention are the polyepoxides, i.e., compounds which contain (or are capable of reacting to contain) two or more epoxy groups. Examples include PEG diglycidyl ether, epichlorohydrin, bisphenol A diglycidyl ether and its prepolymers, etc.

In particular embodiments of this invention, (1) the curable resin used to make the inventive pressure-activated curable resin coated proppants is formed from a phenol aldehyde resin and in particular a novolac resin, while (2) the organofunctional compound is a polyol, especially a polyol based on polyethylene glycol or polypropylene glycol. In these embodiments, diisocyanates and polyisocyanates make especially desirable non-aldehyde functional covalent crosslinking agents, since they readily react with the pendant hydroxymethyl groups of both the polyol and the phenol moieties of the novolac resins. Polyepoxides are also desirable.

### Catalyst for Crosslinking Agent

In accordance with another feature of this invention, a catalyst for the non-aldehyde functional covalent crosslinking agent (also referred to as an “accelerator”) can be included in the coating composition used to form the curable resin coating to facilitate its reaction.

Common types of catalysts or accelerators for many crosslinking agents include acids such as different sulfonic acids and acid phosphates, tertiary amines such as Polycat 9 [bis(3-dimethylaminopropyl)-n,n-demethylpropanediamine] and triethylenediamine (also known as 1,4-diazabicyclo[2.2.2]octane), and metal compounds such as lithium aluminum hydride and organotin, organozirconate and organotitanate compounds. Examples of commercially available catalysts include Tyzor product line (Dorf Ketal); NACURE, K-KURE and K-KAT product lines (King Industries); JEFFCAT product line (Huntsman Corporation) etc. Any and all of these catalysts can be used to accelerate the crosslinking reaction occurring in the inventive technology.

### Proportions

The amounts of resin coatings that can be applied to the proppant particle substrate when practicing this invention are conventional.

For example in conventional curable resin coated proppants containing only a single resin coating, when coated on a sand proppant particle substrate, the amount of curable resin coating is typically 0.5 to 20 wt. %, more typically 0.75 to 10 wt. %, even more typically 1 to 4 wt. %, BOS (i.e., based on the weight of the sand). In contrast, in conventional resin coated proppants containing one, two or more intermediate layers of a fully cured resin coating and a top coat of a curable resin coating, when coated on a sand proppant particle substrate, the amount of fully cured resin in each intermediate layer is typically 0.2 to 20 wt. %, more typically 0.5 to 5 wt. %, even more typically 0.75 to 2 wt. %, BOS, while the amount of curable resin in the top coat is typically 0.2 to 10 wt. %, more typically 0.5 to 5 wt. %, even more typically 0.75 to 2 wt. %, BOS. When conventional curable resin coated proppants are made with something other than sand as the proppant particle substrate, corresponding amounts of curable resin coatings and fully cured resin coating are used.

In practicing this invention, these same amounts of curable resin coatings, as well as fully cured resin coatings, can be used.

The amount of organofunctional compound and non-aldehyde functional covalent crosslinking agent included in the curable resin coating of the inventive curable resin coated should be sufficient to achieve noticeable increases in the resistance to clumping/agglomeration above ground and the resistance to premature consolidation downhole exhibited by the inventive proppant relative to conventional resin coated proppants. In general, this means that the amount of polyol and/or polyamine organofunctional compound included in the curable resin coating will typically be on the order of about 5 wt. % to 40 wt. % BOR, i.e., based on the weight of the curable polymer resin in this curable resin coating. More typically, the amount of this organofunctional compound will be about 10 wt. % to 25 wt. %, about 12 wt. % to 20 wt. % or even about 13 wt. % to 18 wt. %, on this basis. In addition, the amount of non-aldehyde functional covalent crosslinking agent included in this curable resin coating will typically be on the order of 0.1 to 5 wt. %, more typically 0.15 to 2 wt. %, even more typically 0.2 to 1.0 wt. %, or even 0.3 to 0.7 wt. %, BOS.

When the inventive curable resin coated proppants are made with something other than sand as the proppant particle substrate, corresponding amounts of this polyol and/or polyamine organofunctional compound and non-aldehyde functional covalent crosslinking agent are used.

### Method of Manufacture

As indicated above, the normal way in which the resin coating of a conventional resin coated proppant is made is to mix the novolac or other resin forming the resin coating in particulate form with the proppant particle substrate which has previously been heated to a temperature which is high enough to cause the resin to melt and hence coat the individual proppant substrate particles. Hexa or other curing agent is then added with continued vigorous mixing. If a fully cured resin coating is desired, this procedure is carried out at a temperature which is high enough and for a period of time which is long enough to achieve full cure of the resin. If only a partially cured resin coating is desired, i.e., a curable resin coating, then this procedure is carried out at a temperature which is low enough and for a period of time which is short enough to prevent the resin from curing to any significant degree. When multiple resin coatings are desired, the intermediate coating layers are almost always made from fully cured resins. So the way such proppants are typically made is by carrying out the above process repeatedly, since the temperature of the proppant automatically decreases with each additional coating layer as the latent heat in the proppant particle substrate is consumed in melting the resin forming each additional coating layer.

This same general procedure can be used to make the inventive proppants, with the additional ingredients of this invention, i.e., the polyamine and/or polyol organofunctional compound, the non-aldehyde functional covalent crosslinking agent and the optional catalyst for this non-aldehyde functional covalent crosslinking agent, being incorporated into the outermost resin coating of this product in such a way that they become an integral part of this outermost resin coating. This can be done, for example, by adding these additional ingredients to the other ingredients of the curable resin coating, i.e., the curable polymer resin, the conventional non-covalent curing agent for this curable polymer resin and any other additive that might also be present, before it has a chance to solidify—in other words, while it is still molten. As a result, these ingredients as well as reaction products that form from these ingredients become an integral part of this outermost curable resin coating.

This is not to say that that each of these additional ingredients is uniformly or homogenously distributed throughout the entire mass of this curable resin coating. Rather, we are only saying that applying these additional ingredients while the curable resin coating is still molten enables some type of reaction to occur which causes a significant change in the properties of the curable resin coated proppants obtained.

The easiest way of including the additional ingredients of this invention in the outermost curable resin coating of the inventive proppant in a manner so that they become an integral part of this outermost coating is simply by adding these additional ingredients to the mill in which inventive proppant is being made after the curable polymer resin is added but while this resin is still molten in form, i.e., before it solidifies.

For this purpose, the additional ingredients of this invention can be added at the same time as one another or shortly before or after one another. In this context, “shortly before” and “shortly after” connote that, while these ingredients need not be added at exactly the same time, they are added close enough in time so that their effect is essentially the same as if they had been added at the same time as one another. Normally, these ingredients will be added separately from one another to prevent them from reacting before being combined with the curable resin of the curable resin coating. In addition, the catalyst for the non-aldehyde functional covalent crosslinking agent is desirably added last to prevent premature and/or non-uniform reaction of the non-aldehyde functional covalent crosslinking agent. In an especially convenient and effective approach, the ingredients forming the outermost curable resin coating are added in the following order: curable polymer resin, conventional (aldehyde functional) curing agent for the curable polymer resin such as hexa or the like, polyol or polyamine organofunctional compound, non-aldehyde functional covalent crosslinking agent and, finally, the optional catalyst for the non-aldehyde functional covalent crosslinking agent.

Finally, in those instances in which the curable resin coated proppant to be made is intended to cure at temperatures below ˜150° F. (˜66° C.) and the particular non-aldehyde functional covalent crosslinking agent is capable of undergoing rapid reaction with water, an air quench or some other technique for rapidly cooling the proppant after all of the ingredients have been added is desirably used instead of a water quench. On the other hand, if the particular curable resin coated proppant to be made is intended to cure at higher temperatures and/or the non-aldehyde functional covalent crosslinking agent does not rapidly react with water, a water quench can still be used.

### EXAMPLES

In order to more thoroughly describe this invention, working examples were carried out in which the inventive curable resin coated proppants were made and subjected to a number of different analytical tests for determining their properties. The following analytical tests were used:

### Crush Strength

This test measures the ability of individual proppant particles to resist catastrophic failure in response to a large applied stress.

About 65 g of proppant is poured into a test cell and a piston is carefully placed into it. A specified amount of pressure (e.g., 8000 psi to 12000 psi) is applied. The pressure is released, and the crushed proppant sample is sieved. The percentage amount of fines generated is measure of the crush strength of the proppant.

### Unconfined Compressive Strength Test

This UCS test measures the ability of a proppant pack formed from a mass of curable resin coated proppants to resist catastrophic failure when exposed to the high temperatures and pressures the proppant will see in its ultimate use location downhole. This test differs from the crush strength test mentioned above in that the former measures the strength of individual proppant particles, while this test is designed to measure the strength of a proppant pack formed from proppant particles which carry a curable resin coating.

To perform this test, a quantity of the proppant to be tested is mixed with a 2% aqueous KCl solution for 5 minutes to simulate the naturally occurring water the proppant will likely see in use downhole. The proppant slurry is then poured into a cylindrical UCS cell assembly, one side of which has a screen to remove any excess liquid while the other side has a sliding piston. The cell assembly so formed is then maintained for a suitable period of time (e.g., 24 hours) at a predetermined temperature (e.g., 250° F./121° C.) and predetermined pressure (e.g., 1,000 psi/6.9 MPa) which simulate the high temperature and pressure the proppant will see in its ultimate use location downhole. This can be done by placing the cell assembly in a furnace at the predetermined temperature and exerting the predetermined pressure on the piston of the cell. In those instances in which a low temperature condition is being simulated, a suitable toughening agent (activator) can be included in the 2% aqueous KCl solution.

In response to these conditions, any liquid remaining in the proppant mass is removed through the screen. In addition, the resin coatings on the individual proppant particles, which have come into intimate contact with one another as a result of the applied pressure, form particle-to-particle bonds as these resin coatings cure. The result is that a specimen is formed in the shape of the UCS cylindrical cell, this specimen being an amalgamated mass of proppant, i.e., a proppant pack.

The specimen so formed is then removed from the UCS cell and placed in an automated press which measures the maximum axial compressive stress the specimen can withstand before catastrophic failure occurs. Note that, in this test, the specimen is unconfined in the sense that its cylindrical walls are free of any support. As a result, the value generated by this test, which is referred to as the unconfined compressive strength of the curable resin coated proppant and which is normally given in psi or MPa, is an accurate measure of the ability of the proppant pack so formed to resist degradation at the simulated conditions of the test.

When measured by this test under the conditions mentioned above, i.e., 24 hours at 250° F./121° C. and 1,000 psi/6.9 MPa, the inventive curable resin coated proppants desirably exhibit UCS values of 300 psi or more, more desirably 400 psi or more or even 500 psi or more. When measured by this test under the conditions which simulate lower temperature downhole conditions, e.g., 24 hours at 100° F./38° C. and 1,000 psi/6.9 MPa, the inventive curable resin coated proppants desirably exhibit UCS values of 10 psi or more, more desirably 15 psi or more or even 25 psi or more.

### Premature Consolidation Test

When charged downhole, some curable resin coated proppants may amalgamate into clumps or masses before they reach their ultimate use locations. This problem, which is known as premature consolidation, normally becomes more significant as downhole temperatures increase. This Premature Consolidation Test can be used to measure the ability of a proppant to resist this premature consolidation problem. For this purpose, this PCT test is carried out to measure whether a particular proppant will consolidate under the influence of elevated temperature only, e.g., 250° F./121° C., without the influence of any added pressure

This PCT test is carried out in essentially the same way as the UCS Test mentioned above. However, in this test a simulated temperature of 250° F./121° C. and a simulated pressure of 0 psig is used during the 24 hour test period.

When measured by this test, the inventive curable resin coated proppants desirably exhibit PCT values of 40 psi or less, more desirably 25 psi or less or even 15 psi or less.

### 3-Minute Hot Tensile Test (3MT)

This test is normally used to measure whether a curable resin coated proppant has sufficient curability—in other words whether curing of the curable resin coating of this product during manufacture was stopped soon enough to insure that this resin coating is still fully curable. The ability of a curable resin coated proppant to form a strong, coherent proppant pack downhole and hence avoid proppant flowback is due to the bonding of contiguous proppant particles together which, in turn, is due to the fact the resin coatings of contiguous proppant particles undergo substantial cure while they are in intimate contact with one another. It is therefore important that, during manufacture, curing of the curable resin coating of such a product is stopped soon enough so its resin coating is still fully curable. This 3-minute hot tensile test is normally used to measure this property.

In this test, a quantity of the curable resin coated proppant to be tested is poured in a mold, which is then heated without pressure at 450° F. (232° C.) for 3 minutes. The amalgamated proppant mass so formed is then immediately removed from the mold and a tensile force is applied until it breaks. This tensile force or stress, measured in psi, is a measure of the bond strength among contiguous proppant particles and hence a measure of whether the curable resin coating of the proppant exhibits sufficient curability.

In addition to measuring whether a curable resin coated proppant has sufficient curability, this test can also be used to predict whether the inventive curable resin coated proppants will undergo premature consolidation. In particular, because this 3MT test is also carried out without subjecting the proppant to elevated pressure, this test also reflects the tendency of the proppant to consolidate solely in response to elevated temperature.

### Flowability

A problem often encountered with conventional curable resin coated proppants is that they amalgamate or clump together during storage when exposed to the high temperatures and humidities encountered in summertime, especially in Southern states, due to premature cure of their resin coatings. To assess whether a particular curable resin coated proppant may experience this problem, the following flowability test can be performed: 50 grams of proppant in a plastic cup is placed in a humidity chamber set at 125° F. and 90% RH. Visual observation is made about the onset of bonding the cup every hour. The visual observation is classified as:

complete setup—if all the proppant grains have setup into one single pack

clumping—if small clumps of proppant aggregates are visible throughout the sample

free flowing—if there is no visible bonding of proppant grains and all grains completely free flowing

### Leaching Test

Commercial curable novolac resins inherently contain small percentages of unreacted phenols, oligomers and other low molecular weight chemicals. When curable resin coated proppants are made with such resins, these ingredients may leach out into the aqueous liquids these proppants see downhole, including both the hydraulic fracing fluids used to supply these proppants as well as the naturally occurring aqueous liquids found downhole. This can represent a significant environmental problem, and so it is desirable that a curable resin coated proppant avoid this leaching problem to the greatest extent possible.

To determine the ability of a particular curable resin coated proppant to avoid this leaching problem, the following leaching test can be used. 48 grams of proppant is placed into a 300 ml glass pressure vessel, which is then filled with 200 ml of a 2% potassium chloride aqueous solution. The loaded pressure vessel is then capped and placed in an oven set to 125° F. for 120 hours. To simulate the different conditions that might be encountered downhole, this test is run under three different sets of conditions, one in which the potassium chloride aqueous solution is maintained at an acidic pH (pH=2), the second in which the potassium chloride aqueous solution is maintained at a neutral pH (pH=7), and the third in which the potassium chloride aqueous solution is maintained at an alkaline pH (pH=11). Any free phenol which leaches out into the potassium chloride aqueous solution will turn dark red.

Leaching of phenol can also be confirmed quantitatively by extracting the organic content using chloroform and then examining the organic content by NMR (Nuclean Magnetic Resonance) spectrometer.

When determined by this analytical test, the amount of phenol leaching exhibited by the inventive curable resin coated proppants at all three pH levels is desirably 250 ppm or less, more desirably 175 ppm or less and even more desirably 100 ppm or less.

### Comparative Example A

This example represents conventional curable resin coated proppants in that the curable resin coated proppant made in this example comprises two intermediate coating layers of a fully cured novolac resin (including residual hexa, if any) and a final outer coating layer made from a curable novolac resin and a hexa curing agent.

After being heated in a calciner to a temperature of about 550° F. (˜288° C.), 20 pounds (˜9 kg) of northern white sand was placed in a continuously operating pug mill. When the temperature of the sand had dropped to about 450° F. (232° C.), 3 g of a silane coupling agent in water was added followed by the addition of ˜79 grams of a commercially available solid particulate novolac resin and ˜28 grams of hexamethylene tratramine (“hexa”) in the form of a 40% aqueous solution with continuous vigorous mixing. As a result, a first intermediate coating layer comprising a fully cured novolac resin was formed on the proppant particle substrate. Shortly thereafter, when the temperature of the proppant had dropped to about 375° F. (190° C.), the above procedure was repeated, thereby forming a second intermediate coating layer also comprising a fully cured novolac resin.

Shortly thereafter, the above procedure was repeated once again, except in this case a polyethylene glycol toughening agent in the amount of 3.8 wt % BOR was added along with the other ingredients forming this third and last coating layer. Moreover, by this time the ingredients forming this layer were applied, the temperature of the proppant had dropped to about 325° F. (162° C.).

As soon as the newly added novolac resin forming this third and final coating layer had melted to form a uniform coating on the previously made resin coated proppant particle substrate, the proppant was rapidly cooled to below 100° F. (˜38° C.), thereby producing a final coating layer comprising a curable novolac resin. The product so formed was then sieved to remove any clumps or agglomerates that may have formed, thereby producing the final product, i.e., a curable resin coated proppant comprising a proppant particle substrate composed of northern white sand, two intermediate coating layers on the substrate composed of a fully cured novolac resin and a final outer coating layer composed of a curable novolac resin and a polyol toughening agent, with the total amount of novolac resin in this product being 2.6 wt. % BOS, i.e., based on the weight of the sand.

### Examples 1 to 6

Comparative Example A was repeated, except that after the novolac resin forming the outing coating layer had melted and uniformly coated the previously formed resin coated proppant particle substrate and immediately after the hexa was added but before this product was rapidly cooled to below 100° F. (˜38° C.), a polyethylene glycol organofunctional compound in the amount of 3.8 wt % based on the weight of the resin in the outer coating layer, a p-MDI non-aldehyde functional covalent crosslinking agent in the amount of 0.2-0.5 wt. % BOS, and a tertiary amine catalyst in the amount of 10 wt. %, based on the weight of the p-MDI, were added.

The curable resin coated proppants obtained in each of the above examples, including Comparative Example A, were analyzed by four of the analytical tests described above. The results obtained are set forth in the following Table 1:

TABLE 1
Composition and Properties of Inventive Proppants

| | | | | | UCS, psi | | 3MT, |
|---|---|---|---|---|---|---|---|
| | | | | | (1k | PCT, psi | psi |
| | Resin | | | Crush | psi | (0 psi | (0 psi |
| | | Amount, | p-MDI, % | Strength, | 250 F. | 250 F. | 450 F. |
| Example | Type | % BOS | BOS | % fines | 24 hr) | 24 hr) | 3 min) |
| A | 1 | 2.6 | 0 | 5.9 | — | 100 | 120 |
| 1 | 1 | 2.6 | 0.2 | 5.66 | 364 | 31 | 14 |
| 2 | 1 | 2.6 | 0.5 | 5.43 | 402 | 11 | 4 |
| 3 | 1 | 3 | 0.2 | 5.23 | 337 | 47 | 60 |
| 4 | 1 | 3 | 0.45 | 6.28 | 625 | 14 | 0 |
| 5 | 3 | 3 | 0.2 | 5.65 | 666 | 41 | 32 |
| 6 | 2 | 2.6 | 0.5 | 6.34 | 679 | 10 | 0 |

From Table 1, it can be seen that the crush strength of the inventive proppants has not been adversely affected by this invention. In addition, it can also be seen that all of the inventive proppants exhibit substantial UCS values, indicating that they will all form strong, coherent proppant packs. Moreover, the very high UCS values exhibited by the proppants of Example 4, 5 and 6 suggest that these proppants will form especially strong proppant packs.

Table 1 also suggests that the inventive proppants of Examples 1 to 6 will be far less likely to undergo premature consolidation downhole than the conventional proppant of Comparative Example A. This is because these inventive proppants exhibit substantially smaller PCT and 3MT values than this conventional proppant. This, in turn, shows that the strength of the bonds that formed when the inventive proppants are brought together at elevated temperature (250° F.) but no pressure (0 psig) are much weaker than the strength of the bonds that formed when a mass of the conventional proppant is brought together under the same conditions.

This feature of the inventive proppants to resist premature consolidation downhole can also be seen by comparing the PCT value and the UCS value of each inventive proppant with one another. As can be seen from this table, the PCT value of each inventive proppant is much smaller than the UCS value of the same proppant. This shows that the strength of the bond formed under the influence of elevated temperature only is much weaker than the strength of the bond form under the influence of the same elevated temperature but also under the influence of an elevated pressure as well. This, in turn, shows that pressure together with temperature, not temperature alone, is necessary to form a strong bond between contiguous proppants.

This feature of the inventive proppants to resist premature consolidation downhole can also be appreciated by comparing the PCT and 3MT values of the proppant of Comparative Example A with that of the proppants of Examples 1 and 2. Note that these proppants are otherwise identical to one another except for the amount of p-MDI used to make the curable resin coating of each proppant. From this comparison, it can be seen that the conventional proppant which was made with no p-MDI exhibited a PCT value of 100 and an 3MT value of 120. Since both of these tests were carried out at no pressure (i.e., 0 psig), these high PCT and 3MT values indicate that elevated temperature alone is sufficient to develop significant bond strength among contiguous proppant particles. In contrast, the much lower PCT and 3MT values of the inventive proppants indicate that elevated temperature alone is insufficient to develop significant bond strength among contiguous proppant particles, again showing that pressure exerts an important influence.

Note, also that the lower PCT and 3MT values of the inventive proppants of Example 2 relative to the inventive proppant of Example 1 suggests that increasing the amount of p-MDI used to form the inventive proppants achieves a corresponding reduction in the likelihood they will experience premature consolidation downhole.

Finally, comparison of the PCT and 3MT values of Examples 4, 5 and 6 with those of Examples A, 1 and 2, suggests that even when the inventive proppants are formulated to form exceptionally strong proppant packs, nonetheless they will still resist premature cure to a significant degree.

In addition, to the analytical tests mentioned above, the inventive proppants of Examples 1-6 were also subjected to the flowability and leaching analytical tests mentioned above as well as a conventional proppant conductivity test. As a result of these tests, it was found that the conductivities of all the inventive proppants were comparable to conductivity of the conventional proppant of Comparative Example A. In addition, it was further found that the inventive proppants made with 0.4-0.5 wt. % p-MDI BOS exhibited excellent flowabilities under humid conditions as well as no phenol leaching whatsoever.

Together, the examples and analytical tests demonstrate that the premature curing problem that may be experienced by conventional curable resin coated proppants can be eliminated essentially completely, or at least substantially reduced, by this invention without adversely affecting the functionality of the inventive proppants in terms of their ability to form strong, coherent, crush resistant proppant packs.

Although only a few embodiments of this invention have been described above, it should be appreciated that many modifications can be made without departing from the spirit and scope of this invention. All such modifications are intended to be included within the scope of this invention, which is to be limited only by the following claims:

1. A curable resin coated proppant comprising a proppant particle substrate and a curable resin coating on the proppant particle substrate, wherein the curable resin coating comprises the reaction product obtained when a molten mixture comprising a curable polymer resin, an aldehyde functional curing agent for the curable polymer resin, an organofunctional compound comprising one or more polyols, one or more polyamines or a mixture thereof, and a non-aldehyde functional covalent crosslinking agent for the curable polymer resin is coated onto the proppant particle substrate and then solidified in a manner so that the curable polymer resin remains curable.

2. The curable resin coated proppant of claim 1, wherein the curable polymer resin is a phenol aldehyde resin.

3. The curable resin coated proppant of claim 2, wherein the phenol aldehyde resin is a novolac resin.

4. The curable resin coated proppant of claim 1, wherein the non-aldehyde functional covalent crosslinking agent is selected from the group consisting of epoxides, anhydrides, aldehydes, diisocyanates, carbodiamides, divinyl compounds and diallyl compounds.

5. The curable resin coated proppant of claim 4, wherein the non-aldehyde functional covalent crosslinking agent is a diisocyanate.

6. The curable resin coated proppant of claim 5, wherein the diisocyanate is at least one of toluene-diisocyanate, naphthalenediisocyanate, xylene-diisocyanate, tetramethylene diisocyanate, hexamethylene diisocyanate, trimethylene diisocyanate, trimethyl hexamethylene diisocyanate, cyclohexyl-1,2-diisocyanate, cyclohexylene-1,4-diisocyanate, a diphenylmethanediisocyanate and an isocyanate-terminated polyurethane prepolymer.

7. The curable resin coated proppant of claim 6, wherein the diisocyanate is a mixture of diphenylmethanediisocyanates.

8. The curable resin coated proppant of claim 1, wherein the organofunctional compound is a polyol.

9. The curable resin coated proppant of claim 8, wherein the polyol exhibits a plasticizing effect on the curable polymer resin.

10. The curable resin coated proppant of claim 9, wherein the polyol is a hydroxyl terminated polyethylene glycol or a hydroxyl terminated polypropylene glycol.

11. The curable resin coated proppant of claim 1, wherein the curable polymer resin is a novolac, the aldehyde functional curing agent is hexamethylenetetramine, the non-aldehyde functional covalent crosslinking agent is a diisocyanate and the organofunctional compound is a plasticizer for the novolac resin.

12. The curable resin coated proppant of claim 11, wherein the organofunctional compound is a hydroxyl terminated polyethylene glycol or a hydroxyl terminated polypropylene glycol.

13. The curable resin coated proppant of claim 1, wherein the curable resin coated proppant exhibits a UCS value of 10 psi or more, when measured by the UCS analytical test described in the specification carried out under the conditions of 100° F.138° C. and 1,000 psi/6.9 MPa for 24 hours.

14. The curable resin coated proppant of claim 1, wherein the curable resin coated proppant exhibits a PCT value of 40 psi or less when measured by the PCT analytical test described in the specification carried out under the conditions of 250° F./121° C. and 0 psi for 24 hours.

15. The curable resin coated proppant of claim 1, wherein the amount of phenol leaching exhibited by the inventive curable resin coated proppant when subjected to the phenol leaching analytical test described in the specification is less than 100 ppm at pH=2 and at pH=7 and at pH=11.

16. An aqueous fracturing fluid comprising an aqueous carrier liquid and the curable resin coated proppant of claim 1.

17. A method of fracturing a geological formation comprising pumping into the formation the fracturing fluid of claim 15.
